(19) United States
(12) Patent Application Publication
(10) Pub. No.: US 2014/0362779 A1
(43) Pub. Date: Dec. 11, 2014

(54) APPARATUS AND METHODS FOR IMPROVING UPLINK ACCESS IN WIRELESS COMMUNICATION

(71) Applicant: QUALCOMM Incorporated, San Diego, CA (US)

(72) Inventors: Harish VENKATACHARI, Sunnyvale, CA (US); Nate CHIZGI, Sunnyvale, CA (US); Zae Yong CHOI, San Jose, CA (US)

(73) Assignee: QUALCOMM Incorporated, San Diego, CA (US)

(21) Appl. No.: 14/086,691

(22) Filed: Nov. 21, 2013

Related U.S. Application Data
(60) Provisional application No. 61/833,538, filed on Jun. 11, 2013.

(51) Int. Cl. H04W 52/22; H04W 74/08

(52) U.S. Cl. CPC H04W 52/221; H04W 74/0833
USPC 370/329

(57) ABSTRACT

Apparatuses and methods include determining a first initial random access channel (RACH) preamble power based on one or more of a history of RACH preamble powers, a history of common pilot channel (CPICH) chip energy to total power density ratio (EcIo) measurements, and a history of CPICH received signal code power (RSCP) measurements, wherein each of the history of RACH preamble powers, the history of CPICH EcIo measurements, and the history of CPICH RSCP measurements corresponds to previous RACH procedures when the RACH procedure succeeded, and initiating subsequent RACH procedures with preambles that are based on the first initial RACH preamble power. Some present aspects may reduce the push to talk (PTT) call setup latency.

### CLAIM OF PRIORITY UNDER 35 U.S.C. §119

The present application for patent claims priority to U.S. Provisional Application No. 61/833,538 entitled “APPARATUS AND METHODS FOR IMPROVING UPLINK ACCESS IN WIRELESS COMMUNICATION” filed Jun. 11, 2013, and assigned to the assignee hereof and hereby expressly incorporated by reference herein.

### BACKGROUND

Aspects of the present disclosure relate generally to wireless communication systems, and more particularly, to apparatus and methods for improving uplink access in wireless communication.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the spectrum of conventional push-to-talk (PTT) services transitions to the spectrum used in wireless networks such as third generation (3G) and fourth generation (4G) wireless networks, the PTT services may experience reduced quality of service (QoS), for example, with respect to the latency in originating a PTT call. Such latency may result from procedural delays in the wireless network call flow and the latency involved in moving from an idle state to a connected state.

Generally, it may be desirable for a network vendor that a user equipment (UE) in their subscriber network does not roam onto other networks often, so that both the consumers and the service provider may save costs. As such, there are conventional techniques to provide extended downlink coverage for paging (e.g., by using receiver diversity at the UE). However, such conventional techniques need not provide extended uplink coverage for accessing the network.

As the demand for mobile broadband access continues to increase, research and development continue to advance the UMTS technologies not only to meet the growing demand for mobile broadband access, but to advance and enhance the user experience with mobile communications. Thus, in this case, improved uplink access in wireless communication is desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, the disclosure provides a method of wireless communication that includes determining a first initial random access channel (RACH) preamble power based on one or more of a history of RACH preamble powers, a history of common pilot channel (CPICH) chip energy to total power density ratio (EcIo) measurements, and a history of CPICH received signal code power (RSCP) measurements, where each of the history of RACH preamble powers, the history of CPICH EcIo measurements, and the history of CPICH RSCP measurements corresponds to previous successful RACH procedures, and transmitting an initial RACH preamble in subsequent RACH procedures based on the first initial RACH preamble power.

In another aspect, an apparatus for wireless communication is provided that includes a processing system configured to determine a first initial RACH preamble power based on one or more of a history of RACH preamble powers, a history of CPICH EcIo measurements, and a history of CPICH RSCP measurements, where each of the history of RACH preamble powers, the history of CPICH EcIo measurements, and the history of CPICH RSCP measurements corresponds to previous successful RACH procedures, and transmit an initial RACH preamble in subsequent RACH procedures based on the first initial RACH preamble power.

In a further aspect, a computer program product for wireless communication is provided that includes a computer-readable medium including code for determining a first initial RACH preamble power based on one or more of a history of RACH preamble powers, a history of CPICH EcIo measurements, and a history of CPICH RSCP measurements, where each of the history of RACH preamble powers, the history of CPICH EcIo measurements, and the history of CPICH RSCP measurements correspond to previous successful RACH procedures, and code for transmitting an initial RACH preamble in subsequent RACH procedures based on the first initial RACH preamble power.

These and other aspects of the invention will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic block diagram of one aspect of a system for improving uplink access in wireless communication;

FIG. 2 is a flowchart of one aspect of a method of the system of FIG. 1;

FIG. 3 is a block diagram illustrating an example of a hardware implementation for an apparatus of FIG. 1 employing a processing system;

FIG. 4 is a block diagram conceptually illustrating an example of a telecommunications system including aspects of the system of FIG. 1;

FIG. 5 is a conceptual diagram illustrating an example of an access network including aspects of the system of FIG. 1; and

FIG. 6 is a block diagram conceptually illustrating an example of a Node B in communication with a UE in a telecommunications system, including aspects of the system of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

According to some aspects of the present disclosure, an apparatus and method provide an adaptive algorithm to reduce call setup latency, which may be particularly applicable to push-to-talk (PTT) service but may generally apply to any call setup procedure. The conventional call flow for a call setup procedure may include repeated transmission of random access channel (RACH) preambles at increasing power levels, from the originating user equipment (UE) to the network, until an acknowledgement is detected on the downlink. However, according to some present aspects, a UE may maintain a history of RACH preamble powers and/or receiver common pilot channel (CPICH) chip energy to total power density ratio (EcIo) measurements and/or CPICH signal code power (RSCP) measurements corresponding to previous successful RACH procedures (e.g., previous RACH procedures in which the last RACH preamble transmission has been successful). In some aspects, for example, a RACH procedure may include multiple RACH preamble transmissions at increasing power levels. In some aspects, for example, a RACH preamble transmission is successful when the RACH preamble is received at a Node B and an acknowledgement (ACK) or a negative acknowledgement (NACK) is received at the UE on the downlink acquisition indicator channel (AICH) in response to the transmission of the RACH preamble. In these aspects, receiving an ACK indicates that the RACH preamble has been received and the UE has been accepted for accessing network resources, while receiving a NACK indicates that the RACH preamble has been received but the UE has not been accepted for accessing network resources due to, for example, a collision or an allocation of channel resources to a different UE.

In some aspects, the CPICH RSCP is computed as the sum of CPICH_EcIo and the receiver automatic gain control (RxAGC), and the initial RACH preamble power is determined (as may be required by, for example, the 3GPP Standards) as:

Preamble_Initial_Power=Primary CPICH TX power−CPICH_RSCP+UL interference+Constant Value

In some aspects, in future attempts to set up a call, such as but not limited to a PTT call, the UE may use an initial RACH preamble power that is determined based on such previous history (and/or the distribution of such previous history) of RACH preamble power levels and/or receiver CPICH EcIo measurements and/or receiver CPICH RSCP measurements. In the PIT use case, due to the nature of PTT usage that may involve rapid and short bursts of calls on a real time basis, such a history of RACH preamble powers or receiver CPICH EcIo or CPICH RSCP measurements may be used to reduce the number of RACH attempts made before a successful acknowledgement is detected on the downlink. Example PTT users may include emergency responders, people working on a construction site or a vehicular/logistics network, etc. In these example use cases, there may be repeated bursty transmissions on the occurrence of an event or to accomplish a motive. For example, the channel may have long periods of silence as in the example of emergency responders where there is no unusual activity. However, the occurrence of a fire would force bursty communication between users.

In some aspects, additionally or alternatively, when the UE has multiple receiver antennas, the UE may determine the initial RACH preamble power based on individual CPICH EcIo or CPICH RSCP measurements on various antennas. In some aspects, the CPICH RSCP measurements on various antennas are computed as the sum of a respective CPICH EcIo and the RxAGC, and the initial RACH preamble power is determined based on the computed CPICH RSCP. In some aspects, for example, where downlink coverage is extended during idle mode at the UE by using multiple receiver antennas, uplink coverage may also be extended by determining the initial RACH preamble power based on the lowest CPICH EcIo measurement on the antennas or the lowest CPICH RSCP measurement on the antennas. For example, when a UE is in the idle mode and waiting for a page, in order to initiate a mobile originated call, the UE may perform RACH attempts, and the RACH power settings may require the measurement of downlink CPICH EcIo or CPICH RSCP for estimating the uplink channel gains. For UEs with multiple antennas, the UE may decode downlink PICH signals and remain camped without going out of service. However, in some present aspects, the total received CPICH energy across multiple receive antennas of the UE are not used for determining the RACH preamble power, since such total received CPICH energy may not provide a proper estimation of the uplink channel strength in case there is only one receive antenna on the uplink.

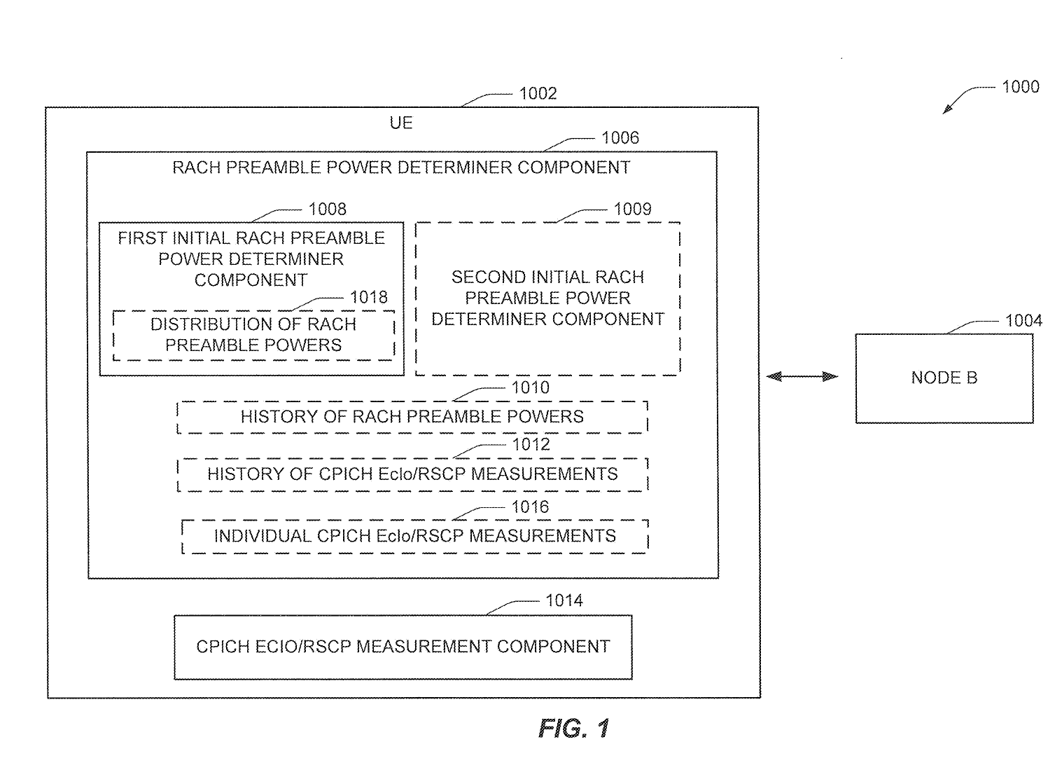

Referring to FIG. 1, in one aspect, system 1000 includes UE 1002 that is communicating with Node B 1004 to set up a call. UE 1002 includes a RACH preamble power determiner component 1006 that determines one or more RACH preamble powers for transmitting one or more RACH preambles to Node B 1004 to set up a call. RACH preamble power determiner component 1006 may include a first initial RACH preamble power determiner component 1008 that determines a first initial RACH preamble power based on a history of RACH preamble powers 1010 corresponding to previous successful RACK procedures. Alternatively or additionally, first initial RACH preamble power determiner component 1008 may determine the first initial RACH preamble power based on a history of CPICH EcIo/RSCP measurements 1012 corresponding to previous successful RACH procedures. For example, in some aspects, the history of CPICH EcIo/RSCP measurements 1012 may include a history of CPICH EcIo measurements corresponding to previous successful RACH procedures and/or a history of CPICH RSCP measurements corresponding to previous successful RACH procedures. In some aspects, alternatively or additionally, first initial RACH preamble power determiner component 1008 may determine the first initial RACH preamble power based on individual CPICH EcIo/RSCP measurements 1016 corresponding to different receiver antennas of UE 1002 (the receive antennas are not shown in FIG. 1), where the individual CPICH EcIo/RSCP measurements 1016 include individual CPICH EcIo measurements and/or individual CPICH RSCP measurements. In some aspects, CPICH EcIo and CPICH RSCP measurements at UE 1002 are determined by CPICH EcIo/RSCP measurement component 1014 based on downlink communication received from Node B 1004.

Optionally, in some aspects, RACH preamble power determiner component 1006 may further include a second initial RACH preamble power determiner component 1009 that, upon the determination of the first initial RACH preamble power by first initial RACH preamble power determiner component 1008, determines a second initial RACH preamble power that is different than the first initial RACH preamble power. For example, the second initial RACH preamble power may be less than the first initial RACH preamble power. The second initial RACH preamble power determiner component 1009 may receive from the first initial RACH preamble power determiner component 1008 an indication and/or information about the determination of the first initial RACH preamble power. Accordingly, in these aspects, power savings at UE 1002 may be achieved by transmitting RACH preambles at a reduced power compared to the first initial RACH preamble power, so that the RACH preamble power may be increased only if an acknowledgment is not received for the transmission of the RACH preamble at the second initial RACH preamble power, that is, a higher RACH preamble power is required to achieve successful transmission. Further, in these aspects, by reducing the RACH preamble power from the first initial RACH preamble power to the second initial RACH preamble power, UE 1002 may save power when channel conditions have improved, that is, previous RACH preamble powers of previous successful RACH procedures are higher than the lowest RACH preamble power that is sufficient for achieving a successful transmission.

In some aspects, upon determining the first and/or the second initial RACH preamble power. UE 1002 may transmit one or more RACH preambles to Node B 1004 based on the first initial RACH preamble power and/or at the second initial RACH preamble power, and, if needed, transmit more RACH preambles at successively higher RACH preamble powers, until an acknowledgement is received.

In some aspects, first initial RACH preamble power determiner component 1008 may determine the first initial RACH preamble power by using the last or most recent RACH preamble power that is stored in the history of RACH preamble powers 1010. e.g., the RACH preamble power of the last or most recent successful RACH preamble transmission.

In some aspects, first initial RACH preamble power determiner component 1008 may determine a distribution of RACH preamble powers 1018 of successful RACH preamble transmissions based on the history of RACH preamble powers 1010, and use the distribution of RACH preamble powers to determine the first initial RACH preamble power. The distribution associated with the distribution of RACH preamble powers 1018 may include information such as, but not limited to, which RACH preamble powers have been used in successful RACH preamble transmissions and how often (e.g., within a certain time period) have those RACH preamble powers been used in successful RACH preamble transmissions. Other information (e.g., statistical information) about such distribution may also be determined including, but not limited to, mean, median, maximum, minimum, range, standard deviations, and/or particular percentiles values. In one non-limiting aspect, for example, a percentile value in the distribution of RACH preamble powers 1018 (e.g., the 90^{th} percentile RACH preamble power in the distribution of RACH preamble powers) may be used to determine the first initial RACH preamble power. In another non-limiting aspect, for example, the first initial RACH preamble power may be set equal to the 90^{th} percentile RACH preamble power in the distribution of RAC preamble powers 1018. For example, in some aspects, the 90^{th} percentile point may represent the 90% point on the distribution of RACH preamble powers that has been constructed over the past successful attempts. It should be noted, however, that any function or percentile may be applied to the distribution of RACH preamble powers, based on a given use case, to use as the first initial RACH preamble power.

In some aspects, first initial RACH preamble power determiner component 1008 may calibrate the first initial RACH preamble power over time. For example, first initial RACH preamble power determiner component 1008 may determine a power offset parameter based on the differences between initial RACH preamble powers in previous successful RACK procedures and corresponding RACH preamble powers that resulted in successful RACH transmissions in the previous successful RACH procedures, and may accordingly adjust the first initial RACH preamble power based on such power offset parameter. In one aspect, for example, if it is determined that a RACH preamble power of, for example, 8 dB above the first initial RACH preamble power has been needed to have a successful RACH preamble transmission, then first initial RACH preamble power determiner component 1008 may calibrate the first initial RACH preamble power within an 8 dB offset.

In some aspects, first initial RACH preamble power determiner component 1008 may calibrate the first initial RACH preamble power to reach a target number of required RACH preamble transmissions (for example, 1.5 transmissions) that is needed to achieve a successful transmission. For example, first initial RACH preamble power determiner component 1008 may adjust a power offset parameter applied to the first initial RACH preamble power based on a target number of required RACH preamble transmissions and the actual number of transmissions attempted until a successful transmission is achieved. In some aspects, for example, first initial RACH preamble power determiner component 1008 may adjust the power offset parameter applied to the first initial RACH preamble power within a power offset range (for example, a range of −3 dB to 9 dB).

In some aspects, first initial RACH preamble power determiner component 1008 may determine an average number of RACH preamble transmission attempts until a successful RACH preamble transmission has been achieved in a set of previous successful RACH procedure. In these aspects, first initial RACH preamble power determiner component 1008 may compare such average number with a threshold or target number of RACH preamble transmission attempts to achieve a successful RACH preamble transmission, and may then determine the power offset parameter accordingly, e.g., increase or decrease the power offset to, respectively, decrease or increase the number of required RACH preamble transmissions that is needed to achieve a successful transmission.

In some aspects, first initial RACH preamble power determiner component 1008 may determine the first initial RACH preamble power alternatively or additionally based on location information of the location information of UE 1002. For example, in some aspects, first initial RACH preamble power determiner component 1008 may determine the first initial RACH preamble power alternatively or additionally based on a subset of the history of RACH preamble powers 1010 that corresponds to a current location of UE 1002, e.g., the RACH preamble powers of previous successful RACH procedures that were performed at the current location of UE 1002.

In some aspects, first initial RACH preamble power determiner component 1008 may determine the first initial RACH preamble power alternatively or additionally based on CPICH EcIo or CPICH RSCP measurements at UE 1002. In one aspect, for example, first initial RACH preamble power determiner component 1008 may determine a CPICH EcIo or CPICH RSCP parameter based on the history of CPICH EcIo/RSCP measurements 1012 that may correspond to successful RACH procedures and/or based on individual CPICH EcIo/RSCP measurements 1016. For example, in one aspect, the CPICH EcIo or CPICH RSCP parameter may be an average (or mean) CPICH EcIo or CPICH RSCP value of the CPICH EcIo or CPICH RSCP measurements within the history of CPICH EcIo/RSCP measurements 1012. In these aspects, first initial RACH preamble power determiner component 1008 may determine the first initial RACH preamble power alternatively or additionally based on the CPICH EcIo or CPICH RSCP parameter.

In some aspects, for example, the downlink coverage of UE 1002 may be extended by using multiple receive antennas (not shown) during the idle mode of the UE 1002, and the usage of multiple antennas provides diversity gains. That is, since the measured total CPICH EcIo or CPICH RSCP may be the better of the individual measurements of multiple antennas or the sum of the gains of the multiple antenna receiver channels, the UE may maintain in-service status even outside the usual cell coverage area of a UE with a single antenna. In these aspects, first initial RACH preamble power determiner component 1008 may determine the first initial RACH preamble power alternatively or additionally based on multiple CPICH EcIo or CPICH RSCP measurements on multiple receiver antennas of UE 1002, where the CPICH EcIo or CPICH RSCP measurements are obtained by CPICH EcIo/RSCP measurement component 1014. The multiple CPICH EcIo or CPICH RSCP measurements may include individual CPICH EcIo/RSCP measurements 1016 on the multiple receiver antennas of UE 1002. Additionally or alternatively, the multiple CPICH EcIo or CPICH RSCP measurements may include previous individual CPICH EcIo or CPICH RSCP measurements on the multiple receiver antennas within history of CPICH EcIo/RSCP measurements 1012 that may correspond to previous successful RACH procedures. For example, in some aspects, first initial RACH preamble power determiner component 1008 may determine the first initial RACH preamble power alternatively or additionally based on the lowest CPICH EcIo measurement within the multiple CPICH EcIo measurements of the multiple receiver antennas of UE 1002 or based on the lowest CPICH RSCP measurement within the multiple CPICH RSCP measurements of the multiple receiver antennas of UE 1002. Accordingly, for example, if there is no receiver diversity at Node B 1004, the lowest CPICH EcIo or CPICH RSCP measurement of the multiple receiver antennas of UE 1002 provides relevant (or conservative) channel quality information to be used for determining the first initial RACH preamble power.

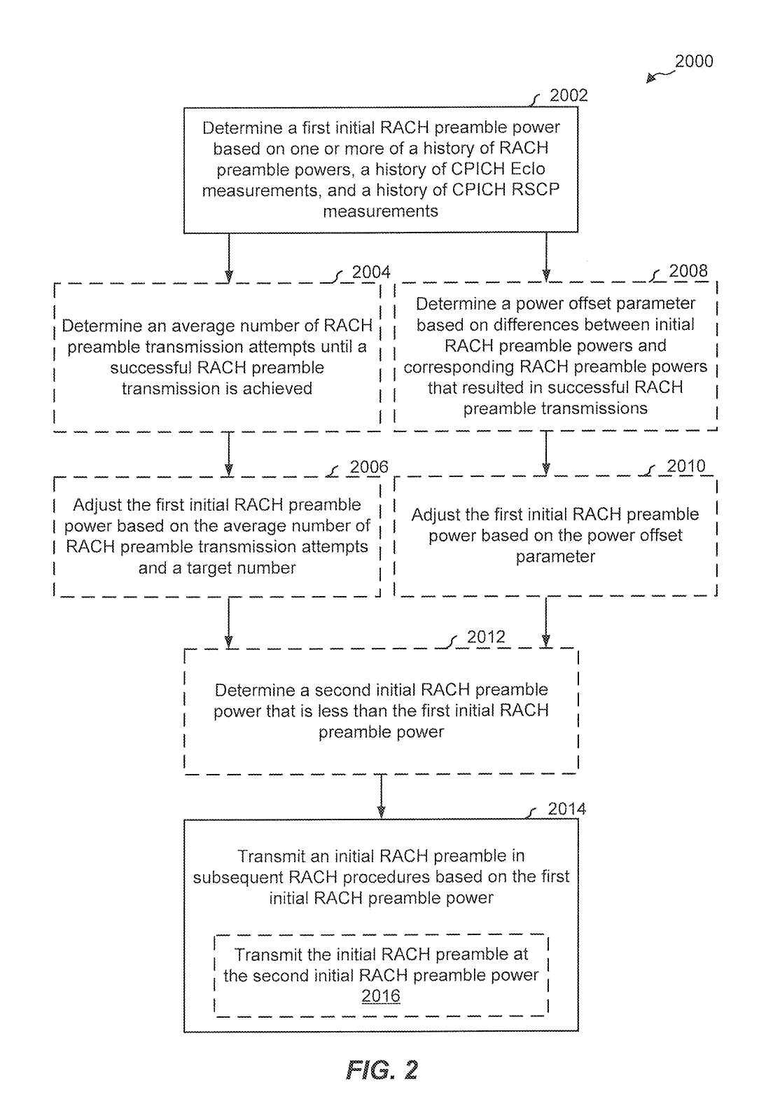

Referring to FIG. 2, in one aspect, a method 2000 for improving uplink access in wireless communication is illustrated. For explanatory purposes, method 2000 will be discussed with reference to the above described FIG. 1. It should be understood that in other implementations, other systems and/or UEs, Node Bs, or other apparatus comprising different components than those illustrated in FIG. 1 may be used in implementing method 2000 of FIG. 2.

At block 2002, method 2000 includes determining a first initial RACH preamble power based on one or more of a history of RACH preamble powers, a history of CPICH EcIo measurements, and a history of CPICH RSCP measurements, where each of the history of RACH preamble powers, the history of CPICH EcIo measurements, and the history of CPICH RSCP measurements corresponds to previous successful RACH procedures. For example, in an aspect. RACH preamble power determiner component 1006 may include first initial RACH preamble power determiner component 1008 that determines a first initial RACH preamble power based on at least one of the history of RACH preamble powers 1010 and the history of CPICH EcIo/RSCP measurements 1012 at UE 1002. In some aspects, for example, first initial RACH preamble power determiner component 1008 determines the first initial RACH preamble power based on a most recent RACH preamble power within the history of RACH preamble powers 1010. In some aspects, for example, first initial RACH preamble power determiner component 1008 determines the first initial RACH preamble power based on a percentile value in a distribution of RACH preamble powers 1018 within the history of RACK preamble powers 1010. In some aspects, for example, first initial RACH preamble power determiner component 1008 determines the first initial RACH preamble power further based on location information of a location of UE 1002 and a history of successful RACH preamble transmit powers at the location of UE 1002.

Optionally, at block 2004, method 2000 includes determining an average number of RACH preamble transmission attempts until a successful RACH preamble transmission is achieved, and at block 2006, method 2000 includes adjusting the first initial RACK preamble power based on the average number of RACH preamble transmission attempts and a target number of RACH preamble transmission attempts according to a targeted delay in success of the subsequent RACH procedures, where the targeted delay corresponds to a time between a first RACH preamble transmission and a successful RACH preamble transmission. For example, in an aspect, first initial RACH preamble power determiner component 1008 determines the first initial RACH preamble power further by determining an average number of RACH preamble transmission attempts until a successful RACH preamble transmission is achieved, and adjusting the first initial RACH preamble power based on the average number of RACH preamble transmission attempts and a target number of RACH preamble transmission attempts (e.g., according to a targeted delay in success of subsequent RACH procedures, where the targeted delay corresponds to a time between a first RACH preamble transmission and a successful RACH preamble transmission). In some aspects, for example, first initial RACH preamble power determiner component 1008 determines the first initial RACK preamble power based on a CPICH EcIo or CPICH RSCP parameter that is based on the history of CPICH EcIo/RSCP measurements 1012. In some aspects, for example, first initial RACH preamble power determiner component 1008 determines the first initial RACH preamble power based on individual CPICH EcIo/RSCP measurements 1016 on multiple receiver antennas of UE 1002. In some aspects, for example, first initial RACH preamble power determiner component 1008 determines the first initial RACH preamble power based on a CPICH EcIo measurement that is the lowest CPICH EcIo measurement within the individual CPICH EcIo/RSCP measurements 1016 on the multiple receiver antennas of UE 1002 or based on a CPICH RSCP measurement that is the lowest CPICH RSCP measurement within the individual CPICH EcIo/RSCP measurements 1016 on the multiple receiver antennas of UE 1002.

Optionally, at block 2008, method 2000 includes determining a power offset parameter based on differences between initial RACH preamble powers in previous successful RACH procedures and corresponding RACH preamble powers that resulted in successful RACK transmissions in the previous successful RACH procedures, and at block 2010, method 2000 includes adjusting the first initial RACH preamble power based on the power offset parameter. For example, in an aspect, first initial RACH preamble power determiner component 1008 determines the first initial RACH preamble power by determining a power offset parameter based on differences between initial RACH preamble powers in previous successful RACH procedures and corresponding RACH preamble powers that resulted in successful RACH transmissions in the previous successful RACK procedures, and adjusting the first initial RACH preamble power based on the power offset parameter.

Optionally, at block 2012, method 2000 includes determining a second initial RACH preamble power that is less than the first initial RACH preamble power. For example, in some aspects, upon the determination of the first initial RACH preamble power by first initial RACH preamble power determiner component 1008, second initial RACH preamble power determiner component 1009 determines a second initial RACH preamble power that is different than the first initial RACH preamble power. In some aspects, the second initial RACH preamble power may be less than the first initial RACH preamble power.

At block 2014, method 2000 includes transmitting an initial RACH preamble in subsequent RACH procedures based on the first initial RACH preamble power. For example, in an aspect, UE 1002 may transmit a RACH preamble to Node B 1004 based on the first initial RACH preamble power determined by first initial RACK preamble power determiner component 1008.

Optionally, block 2014 of method 2000 may include optional block 2016 to transmit an initial RACH preamble in subsequent RACH procedures at the second initial RACH preamble power. For example, in an aspect. UE 1002 may transmit a RACH preamble to Node B 1004 at the second initial RACH preamble power determined by second initial RACH preamble power determiner component 1009.

Accordingly, in some present aspects, by determining the first initial RACH preamble power based on history of RACH preamble powers 1010 and/or history of CPICH EcIo/RSCP measurements 1012 corresponding to previous successful RACH procedures, a reduced call set up time may be achieved. Further, alternatively or additionally, by determining the first initial RACH preamble power based on individual CPICH EcIo/RSCP measurements 1016 on the multiple receiver antennas of UE 1002, extended uplink coverage may be achieved. Even further, alternatively or additionally, by reducing the first initial RACH preamble power to the second initial RACH preamble power, power savings may be achieved when the first initial RACH preamble power is not needed for achieving a successful RACH preamble transmission due to, for example, improved channel conditions.

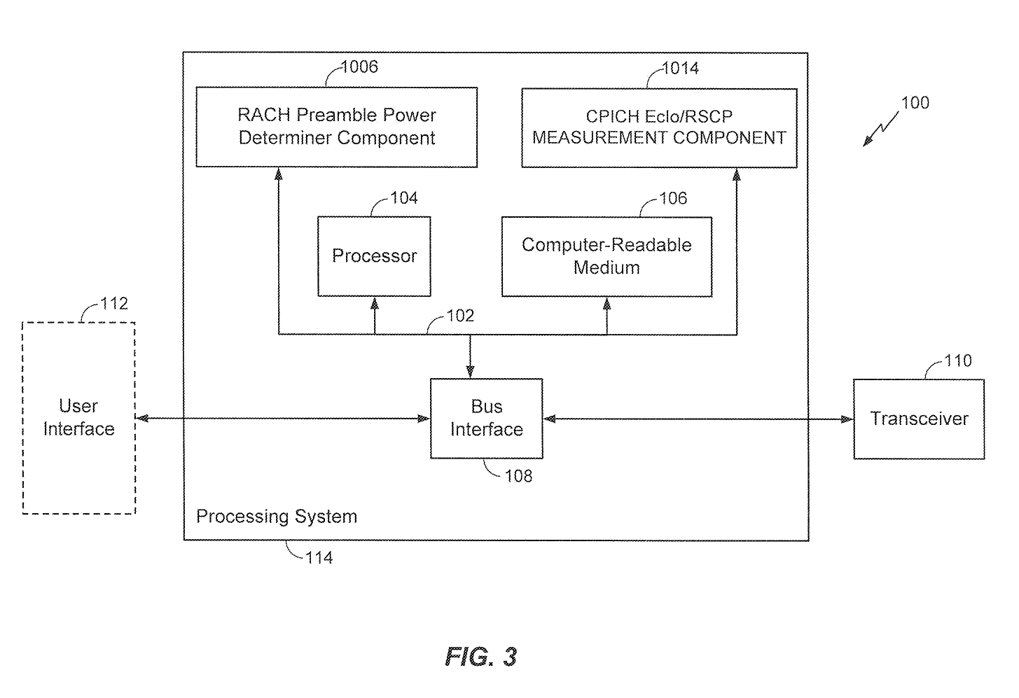

FIG. 3 is a block diagram illustrating an example of a hardware implementation for an apparatus 100 employing a processing system 114 to operate, for example, UE 1002, Node B 1004, RACH preamble power determiner component 1006, CPICH EcIo/RSCP measurement component 1014 (see FIG. 1), and/or respective components thereof. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided. Apparatus 100 further includes RACH preamble power determiner component 1006 and CPICH EcIo/RSCP measurement component 1014 (see FIG. 1) that are linked by bus 102 to other components of apparatus 100.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. In some aspects, at least some of the functions or features supported by the RACH preamble power determiner component 1006 may be implemented, performed, or executed by the processor 104 in connection with the computer-readable medium 106. Similarly, at least some of the functions or features supported by the CPICH EcIo/RSCP measurement component 1014 may be implemented, performed, or executed by the processor 104 in connection with the computer-readable medium 106.

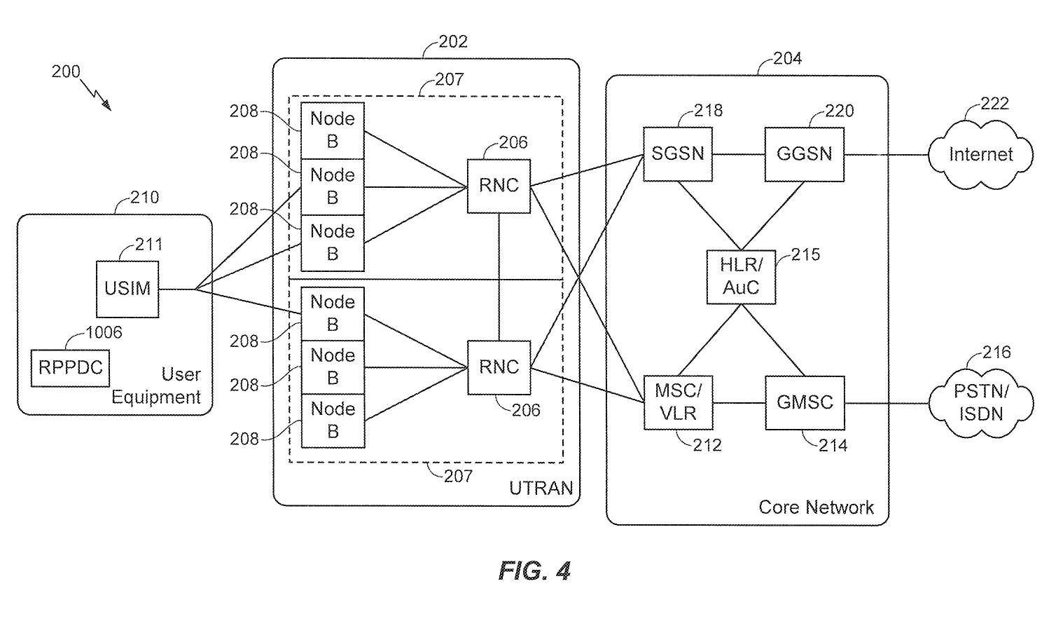

The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. The UTRAN 202 may include the Node B 1004 of FIG. 1 and the UE 210 may be an example of the UE 1002 of FIG. 1. The UE 210 may include RACH preamble power determiner component (RPPDC) 1006, CPICH EcIo/RSCP measurement component 1014 (not shown), or the apparatus 100 of FIG. 3 which includes RACH preamble power determiner component 1006 and CPICH EcIo/RSCP measurement component 1014. In some aspects, for example, the RPPDC 1006 of the UE 210 may determine a first initial RACH preamble power based on one or more of a history of RACH preamble powers, a history of CPICH EcIo measurements, and a history of CPICH RSCP measurements, where each of the history of RACH preamble powers, the history of CPICH EcIo measurements, and the history of CPICH RSCP measurements corresponds to previous successful RACH procedures. The RPPDC 1006 of the UE 210 may then transmit an initial RACH preamble in subsequent RACH procedures based on the first initial RACH preamble power to a Node B 208 in the UTRAN 202.

In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

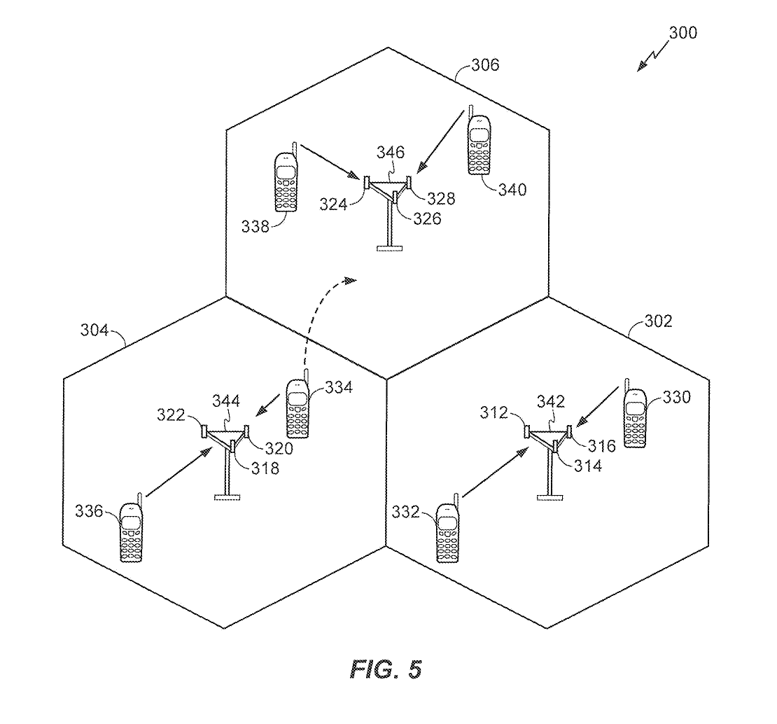

Referring to FIG. 5, an access network 300 in a UTRAN architecture is illustrated in which one or more of the wireless communication entities, e.g., UEs and/or base stations, may include UE 1002, 210, Node B 1004, 208, RACH preamble power determiner component 1006. CPICH EcIo/RSCP measurement component 1014, or apparatus 100 (see FIGS. 1, 3, and 4). For example, in an aspect, UEs 330, 332, 334, 336, 338, and 340 may include the RPPDC 1006 of the UE 210 in FIG. 4, which may determine a first initial RACH preamble power based on one or more of a history of RACH preamble powers, a history of CPICH EcIo measurements, and a history of CPICH RSCP measurements, where each of the history of RACH preamble powers, the history of CPICH EcIo measurements, and the history of CPICH RSCP measurements corresponds to previous successful RACH procedures. The RPPDC 1006 may then transmit an initial RACH preamble in subsequent RACH procedures based on the first initial RACH preamble power to a respective Node B, e.g., Node B 342, 344, or 346.

The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 4) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 4), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

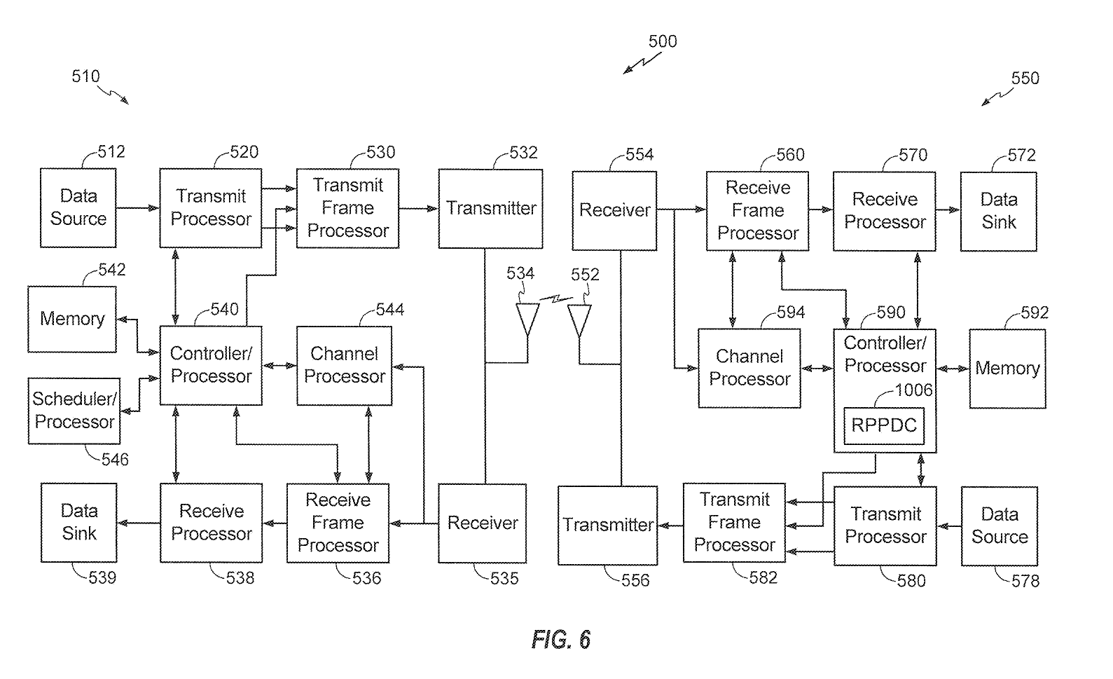

FIG. 6 is a block diagram of a Node B 510 in communication with a UE 550, where Node B 510 may be an example of Node B 1004 of FIG. 1 and UE 550 may be an example of the UE 1002 of FIG. 1. The UE 550 may include RACH preamble power determiner component (RPPDC) 1006, CPICH EcIo/RSCP measurement component 1014 (not shown), or the apparatus 100 of FIG. 3 which includes RACH preamble power determiner component 1006 and CPICH EcIo/RSCP measurement component 1014. In some aspects, for example, the RPPDC 1006 of the UE 550 may determine a first initial RACH preamble power based on one or more of a history of RACH preamble powers, a history of CPICH EcIo measurements, and a history of CPICH RSCP measurements, where each of the history of RACH preamble powers, the history of CPICH EcIo measurements, and the history of CPICH RSCP measurements corresponds to previous successful RACH procedures. The RPPDC 1006 of the UE 550 may then transmit an initial RACH preamble in subsequent RACH procedures based on the first initial RACH preamble power to a Node B 550. In the downlink communication, a transmit processor 520 may receive data from a data source 512 and control signals from a controller/processor 540. The transmit processor 520 provides various signal processing functions for the data and control signals, as well as reference signals (e.g. pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining a first initial random access channel (RACH) preamble power based on one or more of a history of RACK preamble powers, a history of common pilot channel (CPICH) chip energy to total power density ratio (EcIo) measurements, and a history of CPICH received signal code power (RSCP) measurements, wherein each of the history of RACH preamble powers, the history of CPICH EcIo measurements, and the history of CPICH RSCP measurements corresponds to previous successful RACH procedures; and
transmitting an initial RACH preamble in subsequent RACH procedures based on the first initial RACH preamble power.

2. The method of claim 1, further comprising:
determining a second initial RACH preamble power that is less than the first initial RACH preamble power, wherein the transmitting the initial RACH preamble in the subsequent RACH procedures is at the second initial RACH preamble power.

3. The method of claim 1, wherein the first initial RACH preamble power is based on a most recent RACH preamble power within the history of RACH preamble powers.

4. The method of claim 1, wherein the first initial RACH preamble power is based on a percentile value in a distribution of RACH preamble powers within the history of RACH preamble powers.

5. The method of claim 1, wherein the determining the first initial RACH preamble power further comprises:
determining an average number of RACH preamble transmission attempts until a successful RACH preamble transmission is achieved; and
adjusting the first initial RACH preamble power based on the average number of RACH preamble transmission attempts and a target number of RACH preamble transmission attempts according to a targeted delay in success of the subsequent RACH procedures, wherein the targeted delay corresponds to a time between a first RACH preamble transmission and a successful RACH preamble transmission.

6. The method of claim 1, wherein the determining the first initial RACH preamble power further comprises:
determining a power offset parameter based on differences between initial RACH preamble powers in the previous successful RACH procedures and corresponding RACH preamble powers that resulted in successful RACH preamble transmissions in the previous successful RACH procedures; and
adjusting the first initial RACH preamble power based on the power offset parameter.

7. The method of claim 1, wherein the determining the first initial RACH preamble power is further based on location information of a location of a user equipment and a history of successful RACH preamble transmit powers at the location.

8. The method of claim 1, wherein the determining the first initial RACH preamble power is based on a CPICH EcIo or CPICH RSCP parameter that is based on the history of CPICH EcIo measurements or the history of CPICH RSCP measurements.

9. The method of claim 1, wherein the determining the first initial RACH preamble power is based on individual CPICH EcIo or CPICH RSCP measurements on multiple receiver antennas of a user equipment.

10. The method of claim 1, wherein the determining the first initial RACH preamble power is
based on a CPICH EcIo measurement that is a lowest CPICH EcIo measurement on multiple receiver antennas of a user equipment, or
based on a CPICH RSCP measurement that is a lowest CPICH RSCP measurement on the multiple receiver antennas of the user equipment.

11. An apparatus for wireless communication, comprising:
a processing system configured to:
determine a first initial random access channel (RACH) preamble power based on one or more of a history of RACH preamble powers, a history of common pilot channel (CPICH) chip energy to total power density ratio (EcIo) measurements, and a history of CPICH received signal code power (RSCP) measurements, wherein each of the history of RACH preamble powers, the history of CPICH EcIo measurements, and the history of CPICH RSCP measurements corresponds to previous successful RACH procedures; and
transmit an initial RACH preamble in subsequent RACH procedures based on the first initial RACH preamble power.

12. The apparatus of claim 11, wherein the processing system is further configured to:
determine a second initial RACH preamble power that is less than the first initial RACH preamble power, wherein the processing system is configured to transmit the initial RACH preamble in the subsequent RACH procedures at the second initial RACH preamble power.

13. The apparatus of claim 11, wherein the first initial RACH preamble power is based on a most recent RACH preamble power within the history of RACH preamble powers.

14. The apparatus of claim 11, wherein the first initial RACH preamble power is based on a percentile value in a distribution of RACH preamble powers within the history of RACH preamble powers.

15. The apparatus of claim 11, wherein the processing system is configured to determine the first initial RACH preamble power further by:
determining an average number of RACH preamble transmission attempts until a successful RACH preamble transmission is achieved; and
adjusting the first initial RACH preamble power based on the average number of RACH preamble transmission attempts and a target number of RACH preamble transmission attempts according to a targeted delay in success of the subsequent RACH procedures, wherein the targeted delay corresponds to a time between a first RACH preamble transmission and a successful RACH preamble transmission.

16. The apparatus of claim 11, wherein the processing system is configured to determine the first initial RACH preamble power further by:
determining a power offset parameter based on differences between initial RACH preamble powers in the previous successful RACH procedures and corresponding RACH preamble powers that resulted in successful RACH preamble transmissions in the previous successful RACH procedures; and
adjusting the first initial RACH preamble power based on the power offset parameter.

17. The apparatus of claim 11, wherein the processing system is configured to determine the first initial RACH preamble power further based on location information of a location of a user equipment and a history of successful RACH preamble transmit powers at the location.

18. The apparatus of claim 11, wherein the processing system is configured to determine the first initial RACH preamble power based on a CPICH EcIo or CPICH RSCP parameter that is based on the history of CPICH EcIo measurements or the history of CPICH RSCP measurements.

19. The apparatus of claim 11, wherein the processing system is configured to determine the first initial RACH preamble power based on individual CPICH EcIo or CPICH RSCP measurements on multiple receiver antennas of a user equipment.

20. A computer program product for wireless communication, comprising:
a computer-readable medium comprising:
code for determining a first initial random access channel (RACH) preamble power based on one or more of a history of RACH preamble powers, a history of common pilot channel (CPICH) chip energy to total power density ratio (EcIo) measurements, and a history of CPICH received signal code power (RSCP) measurements, wherein each of the history of RACH preamble powers, the history of CPICH EcIo measurements, and the history of CPICH RSCP measurements corresponds to previous successful RACH procedures; and
code for transmitting an initial RACH preamble in subsequent RACH procedures based on the first initial RACH preamble power.
